(19) United States
(12) Patent Application Publication
(10) Pub. No.: US 2026/0287324 A1
(43) Pub. Date: Sep. 24, 2026

(54) MAGNETIC SIGNALLING DEVICE AND COMPONENT EQUIPPED WITH SAME

(71) Applicant: Miba eMobility GmbH, Laakirchen (AT)

(72) Inventors: Stefan KAGERER, Gmunden (AT); Sebastian SCHLAGER, Timelkam (AT)

(73) Assignee: Miba eMobility GmbH, Laakirchen (AT)

(21) Appl. No.: 18/874,208

(22) PCT Filed: Jun. 13, 2023
(86) PCT No.: PCT/AT2023/060185

§ 371 Date: Dec. 12, 2024

(30) Foreign Application Priority Data
Jun. 13, 2022 (AT) A50414/2022

(51) Int. Cl. G01B 7/30; H02K 1/02; H02K 11/21

(52) U.S. Cl. CPC G01B 7/30; H02K 1/02; H02K 11/21

(57) ABSTRACT

In a magnetic signaling device for measuring the movement and/or the position of a rotating component, as well as this rotating component, at least one magnetic track extending along the circumference in the form of a magnetizable, hard-magnetic layer of a rare earth magnetic material deposited directly on the carrier from a gas phase, is applied to an annular or disc-shaped carrier for connection to the component. The carrier is made of a material with a higher ductility than that of the hard magnetic layer.

The invention relates to a magnetic signaling device for measuring the movement and/or position of a component of a drive machine, in particular a pole wheel for use in a rotational angle or rotational speed monitoring system.

The determination of angles of rotation and/or rotational speeds of rotating parts is an essential object in many technical fields. The most frequently used measuring principle for high-precision applications is optical or photoelectric scanning. However, this is fundamentally sensitive to environmental influences such as shock and vibration loads, dirt, temperature fluctuations and humidity. Special housing designs intended to compensate for this lead to certain limitations in terms of mounting options, and the costs increase disproportionately with larger shaft diameters, making technically and economically viable solutions virtually impossible.

Resolvers, i.e. electrical transformers, are used to measure the rotational angle. The inductive coupling between the windings of the transformer varies depending on the angle. When an alternating current signal is applied, the measurement at the windings of the transformer results in an electrical alternating current signal whose amplitude is proportional to the angle. Resolvers are often used in safety systems due to their reliability. However, the resolution is very much determined by the quality of the analog-to-digital conversion, which means that resolver-based systems are complex, often heavy, bulky and expensive.

Encoders with a magnetic measuring principle are an alternative. Due to their insensitivity to shock and vibration as well as to dirt, temperature fluctuations and moisture, magnetic encoders can be used primarily in applications where the service life of optical encoders is limited despite elaborate protective housings. These are areas of application in which the encoders are exposed to high temperatures, temperature fluctuations, dirt and dust and/or contamination with chemicals and solvents.

In the field of automotive engineering, for example, rotational speed monitoring on the wheels to control an anti-lock braking system or an anti-slip control system is a common technology. For this purpose and for other rotational speed monitoring, pole wheels with an adjacent sensor are usually used, the sensor emitting an oscillating signal whose frequency is a measure of the rotational speed of the pole wheel and thus also of the rotating part of the vehicle or other machine that is permanently connected to it, when the pole wheel rotates relative to the sensor. At least one magnetic track is arranged on the circumference of the pole wheel, which is evaluated using coils or magnetic field sensors. Like an incremental encoder, the pole wheel is used as a rotational speed or angle sensor; it is relatively insensitive to dirt and can usually be manufactured quite cheaply.

The magnetic graduation of a pole wheel and/or encoder mounted on the rotating shaft is the signal transmitter for a sensor. Such an encoder is known, for example, from EP1030181A2. The electronics are integrated in the scanning head with a high degree of protection and can be completely encapsulated if required. Thanks to the two-part system design with pole wheel and scanning head, magnetic encoders can be used without a complex protective housing and additional ball bearings-this means that a virtually wear-free solution with a very long service life can be realized. Furthermore, such systems do not require a free shaft end for installation and are therefore well suited for integration in electric motors, for example in electric cars. Publication DE102016218930A1 shows another such product. Alternatively, publication DE102018217274A1, for example, shows the manufacture of a ring of sintered partial magnets, each connected to polymer-based intermediate pieces.

Pole wheels exist in a wide variety of designs. For example, DE10210372A1 discloses a rotational angle sensor with high angular resolution, which has a magnetic track on a pole wheel in which magnetic north and south poles are arranged alternately and whose position relative to a rotationally fixed component is detected with a magnetic field sensor. One possible design example described is a pole wheel made of plastic or synthetic resin with ferromagnetic components mixed in, which is easy and inexpensive to manufacture. According to DE10210372A1, the magnetic tracks can be formed from magnetized ferrite foil, among other things, which can be produced easily and also inexpensively. Alternatively, magnetic tracks made of magnetized ferrite bonded in rubber, synthetic resin or caoutchouc are also possible. Furthermore, EP0213732A1 discloses a sensor system for detecting the rotation of an object, comprising a magnetic ring which is constructed from a synthetic resin with embedded ferromagnetic materials.

The object of the present invention was to overcome the disadvantages of the prior art and to provide a device which offers high precision in a safe manner unaffected by disturbances of any kind and which can be used flexibly in a wide variety of areas under a wide variety of operating conditions.

This technical object is reached by a magnetic signaling device according to the claims. Further features can be found in the description and the drawings.

The device according to the invention is based on a magnetic signaling device for measuring the movement and/or the position of a rotating component, in particular a component of a drive machine, comprising an annular or disk-shaped carrier for connection to the component, and at least one magnetic track extending along the circumference in the form of a magnetizable, hard magnetic layer deposited directly on the carrier from a gas phase and consists of at least 75% by weight of a rare earth magnet material, preferably one or more of the compounds NdFeB and/or Co5Sm and/or Co17Sm2, the layer having a magnetic structure after magnetization in the direction of rotation which can be measured by a sensor. The proportion of the respective rare earth metal per se is preferably less than 75% by weight of the hard magnetic layer.

In order to attain the object set, such a signaling device according to the invention is characterized in that the carrier consists of a material with a higher ductility than that of the hard magnetic layer. The low layer thickness of the hard magnetic layer and its application to ductile material relativizes the brittleness of the hard magnetic material. Despite the brittleness of the hard magnetic material, the particularly thin layer of hard magnetic material on the carrier made of ductile material enables the signaling device to be pressed directly onto a component, in particular onto a shaft of a machine.

The carrier is preferably made of a metallic material. Austenitic or ferritic stainless steel is particularly preferred.

According to a further preferred embodiment of the invention, the hard magnetic layer was applied to the carrier using a PVD process. This allows the targeted optimization of the magnetic properties through changes in the layer structure that arise under different process conditions. A constant layer thickness, as can be achieved in PVD processes, also ensures high concentricity of the signaling device. This enables the use of pole wheels, for example, even in high rotational speed ranges above 30,000 revolutions per minute.

The embodiment of the magnetic signaling device according to the invention as a rotationally symmetrical pole wheel in a rotational angle and/or rotational speed measuring arrangement is particularly advantageous.

The solution of the object posed at the beginning is also possible for a rotating component, in particular a component of a drive machine, with a magnetic signaling device for measuring the movement and/or the position of the component. The starting point for this is a component comprising an annular or disc-shaped carrier for connection to the component, as well as at least one magnetic track extending along the circumference in the form of a magnetizable, hard magnetic layer deposited directly on the carrier from a gas phase and containing at least 75% by weight of a rare earth magnetic material, preferably one or more of the compounds NdFeB and/or Co5Sm and/or Co17Sm2, the layer having, after magnetization in the direction of rotation, a magnetic structure which can be measured by a sensor. Again, the proportion of the respective rare earth metal per se is preferably less than 75% by weight of the hard magnetic layer.

According to the invention, this component is characterized in that the carrier is made of a material with a higher ductility than that of the hard magnetic layer and is pressed with the rotating component.

The carrier for this component is preferably made of a metallic material, preferably ferritic steel.

According to a preferred embodiment of the invention, the hard magnetic layer was preferably applied to the carrier using a PVD process.

For a better understanding of the invention, it is explained in more detail with the aid of the following figures.

The figures show in a highly simplified, schematic representation:

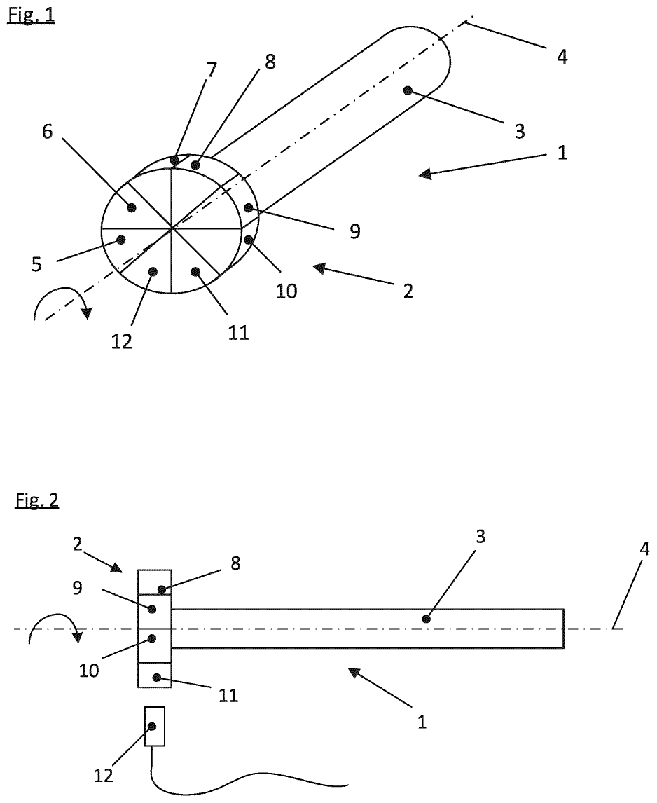

FIG. 1 a schematic perspective view of a magnetic signaling device;

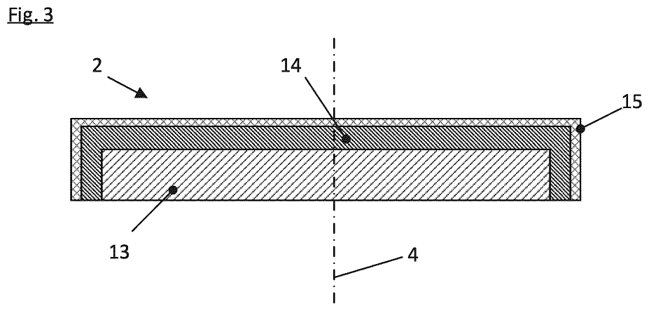

FIG. 2 a schematic view of an inventive magnetic detection device in a plan view, and

FIG. 3 a sectional view of a part of a magnetic signaling device.

By way of introduction, it should be noted that in the differently described embodiments, the same parts are provided with the same reference signs or the same component designations, whereby the disclosures contained in the entire description can be transferred analogously to the same parts with the same reference signs or the same component designations. The position details selected in the description, such as top, bottom, side, etc., also refer to the directly described and illustrated figure and these position details are to be transferred analogously to the new position if the position is changed.

FIG. 1 shows a schematic representation of a magnetic signaling device 1, which is used in particular to measure the movement and/or position of a rotating component, especially a component of a drive machine, in the automotive sector but also in the industrial sector. The magnetic signaling device 1 is configured, for example, with a rotationally symmetrical pole wheel 2. This pole wheel 2 is non-rotatably connected to a shaft 3, which is an example of a component whose rotational position or rotational speed is to be determined. The shaft 3 rotates about an axis of rotation 4 and is connected, for example, to a gearbox or a drive unit (not shown). In this way, the pole wheel 2 can be used to measure the rotation and/or position of the shaft 3 and further of the gearbox or the drive machine.

As can also be seen in FIG. 1, the pole wheel has corresponding sections 5, 6, 7, 8, 9, 10, 11, 12, which have a hard-magnetic, purely metallic layer without polymer content with alternating magnetization, as magnetic poles. According to a particular embodiment of the invention, a maximum operating temperature (also long-term) of up to 250° C. is thus possible. The hard magnetic layer is magnetized via a suitable magnetization device. As can be seen from FIG. 1 and FIG. 2, the hard magnetic layer is arranged on the front surface of the pole wheel as well as on the radial circumferential surface. In FIG. 2, the individual poles 8, 9, 10, 11 are shown on a part of the radial circumferential surface. In addition, a detector 12 of a rotational angle and/or rotational speed measuring arrangement is shown, which is arranged at a predetermined distance from the pole wheel 2. The detector 12 is, for example, a detector/sensor that is based on the XMR and/or Hall measuring principle and measures the rotation and/or position of the pole wheel 2 in high resolution. An XMR sensor is a sensor that works magnetoresistively, i.e. the sensor changes its resistance under the influence of the magnetic flux. So-called AMR, GMR and TMR sensors, which are subsumed under XMR sensors, are known from the state of the art. According to a particular embodiment of the invention, the sensor and the magnetic signaling device have a resolution of 10 to 20 bits, in particular on one or more tracks. According to a particular embodiment, a distance of between 0.1 mm and 3 mm is provided between the sensor and the magnetic signaling device.

FIG. 3 shows schematically the structure of the pole wheel 2 in detail. The pole wheel 2 has a support structure 13, for example in the form of a disk or ring. The hard magnetic layer according to the invention is applied to this support structure 13, which is made of a more ductile material than the hard magnetic layer 5 to 12. The carrier 13 is preferably made of a metallic material such as steel, stainless steel, copper, brass or aluminum. Austenitic or ferritic stainless steel, which is known for its excellent ductility, is particularly preferred. They are also generally characterized by a high chromium and low carbon content, as well as excellent weldability and other positive technical properties.

The particularly thin layer-between 1 and 150 μm—of the hard magnetic material of layers 5 to 12 on the carrier 13 made of ductile material enables the signaling device 1 to be pressed directly onto the shaft 3 despite the brittleness of the hard magnetic material.

In the case shown, the hard magnetic layer is applied as at least one magnetic track of very low layer thickness extending along the circumference, i.e. the entire radial circumferential surface and/or on one of the two end faces of the pole wheel 2. According to a particular embodiment of the invention, the hard magnetic layer is only provided in the scanning region of the sensor 12. According to a further preferred embodiment of the invention, a protective layer 15 is provided over the hard magnetic layer, which protects the scanned hard magnetic layer from damage and/or environmental influences.

The hard magnetic layer 5 to 12 is preferably applied to the carrier 13 using a PVD process in order to allow targeted optimization of the magnetic properties. In the field of PVD processes, for example, it is possible to generate ions via a glow discharge of a hollow cathode and to apply or sputter the ions generated in this way onto a surface.

By specifically controlling the PVD process, the layer morphology can be adjusted from amorphous to semi-crystalline to crystalline. The process also enables the deposition of crystalline, single-phase layers such as Co17Sm2, Co5Sm. This can be done by adjusting the coating parameters. The layer structure can also be optimized for the various magnetization processes, e.g. in-plane or out-of-plane.

Alternatively, the hard magnetic layer could also be applied by at least one of the processes of hollow cathode gas-flow sputtering and/or hollow cathode sputtering and/or electroplating and/or CVD and/or plasma spraying. The layer 5 to 12 consists of at least 75% by weight of one or more of the following compounds such as NdFeB and/or Co5Sm and/or Co17Sm2, in particular with/without doping or alloying with other elements such as Fe, Cu, Zr. In relation to the composition of the hard magnetic layer, up to 10% by weight of alloying elements can be present. Other rare earth materials can also be used, in particular neodymium, praseodymium, terbium and dysprosium. The respective rare earth metal, e.g. neodymium or samarium, is preferably present at less than 75% by weight in layer 5 to 12.

With a Curie temperature of more than 700° C., CoSm has excellent temperature resistance. Furthermore, the very homogeneous microcrystalline structure of the layer in combination with an easily controllable layer thickness allows very precise magnetization with an angular accuracy of less than 0.1°. If such pole wheels are combined with suitable sensors, resolutions of up to 18 bits can be achieved. This makes a signaling device according to the invention ideally suited for purely digital signal processing and can achieve accuracies that could previously only be covered by optical systems while at the same time being known to be robust. The achievable accuracy also fulfills the criteria for use in electric motors to control the rotors as a replacement for resolvers.

A further advantage over the state of the art is the insensitivity to organic solvents, oils and greases, as in particular no carbon-based polymers are used. This innovation represents a decisive added value for increasing efficiency, especially in environments with oil mist, such as in the area of high-performance electric motors and drive trains of electric cars.

It is also possible to dispense with the housing and use a combination of a pole wheel, which is placed directly on the shaft, and a separate evaluation unit (bearingless encoder). This makes it possible to integrate the measuring unit directly, e.g. in an electric motor, and also eliminates the need for a free end of the shaft for mounting.

Furthermore, the use of hard magnetic layers requires a very high stability against demagnetization or remagnetization, which significantly increases the stability against (even very strong) interference fields. Co5Sm compounds, for example, have coercive field strengths of up to 750 kA/m.

If higher rotational speeds are required, conventional systems either require a support ring on the outside of the pole wheel or the use of gear wheels as signal transmitters (back-bias arrangement). However, this is at the expense of accuracy, and such a configuration also requires a very small distance between the sensor and the wheel, which often cannot be guaranteed due to real tolerances.

Preferably, the hard magnetic layer has a magnetic remanence of 0.1 T to 1.3 T in its scanning region.

In an advantageous embodiment of the invention, the hard magnetic layer has an average thickness of between 10 um and 100 μm in its scanning region, preferably more than 15 μm, particularly preferably more than 25 μm or between 25 μm and 60 μm. This means that the amount of expensive rare earths required can be significantly reduced.

The layer thickness can be set with a precision of less than or equal to +/−0.2 μm, in particular less than or equal to +/−0.1 μm, which significantly improves precision. In particular, a precision advantage can be achieved with in-plane magnetization due to the particularly high aspect ratio between layer thickness and magnetic pole width.

Above the hard magnetic layer, a further layer, preferably with an average thickness of up to 10 μm, can advantageously be provided in the scanning region as a protective layer to protect the hard magnetic layer 5 to 12.

In addition to the embodiment of the magnetic signaling device 1 with a pole wheel 2 shown so far, a rotationally symmetrical encoder could also be provided.

According to a particular embodiment of the invention, an angular accuracy of less than or equal to +−0.1° between the differently magnetizable regions can be achieved when magnetizing the hard magnetic layer. This means that the structure of the magnetization can be realized very finely.

The embodiment examples show possible embodiment variants, whereby it should be noted at this point that the invention is not limited to the specifically illustrated embodiment variants thereof, but rather various combinations of the individual embodiment variants with one another are also possible and this variation possibility lies within the ability of the skilled person working in this technical field due to the teaching on technical action by the present invention.

1. A magnetic signaling device (1) for measuring the movement and/or the position of a rotating component (3), in particular a component of a driving machine, comprising an annular or disc-shaped carrier (13) for connection to the component (3), and at least one magnetic track extending along the circumference in the form of a magnetizable, hard-magnetic layer (5 to 12) deposited directly on the carrier from a gas phase and comprises at least 75% by weight of a rare-earth magnetic material, preferably one or more of the compounds NdFeB and/or Co5Sm and/or Co17Sm2, wherein the magnetizable layer (5 to 12), after magnetization in the direction of rotation, has a magnetic structure which can be measured by a sensor (12),
wherein
the carrier (13) comprises a material with higher ductility than that of the hard magnetic layer (5 to 12).

2. The signaling device according to claim 1, wherein the carrier (13) comprises a metallic material, preferably austenitic or ferritic stainless steel.

3. The signaling device according to claim 1, wherein the hard magnetic layer (5 to 12) was preferably applied to the carrier (13) by means of a PVD process.

4. The signaling device according to claim 1, wherein the hard magnetic layer (5 to 12) is adjusted from amorphous to semi-crystalline to crystalline by selective control of the PVD process.

5. The magnetic signaling device according to claim 1, in an embodiment as a rotationally symmetrical pole wheel (2) in a rotational angle and/or rotational speed measuring arrangement.

6. A rotating component (3), in particular a component of a drive machine, with a magnetic signaling device (1) for measuring the movement and/or the position of the component, comprising an annular or disc-shaped carrier (13) for connection to the component (3), and at least one magnetic track extending along the circumference in the form of a magnetizable layer (5 to 12) which is deposited directly on the carrier (13) from a gas phase, hard magnetic layer (5 to 12) containing at least 75% by weight of a rare earth magnetic material, preferably one or more of the compounds NdFeB and/or Co5Sm and/or Co17Sm2, the layer having, after magnetization in the direction of rotation, a magnetic structure which can be measured by a sensor,
wherein
the carrier (13) consists comprises a material with a higher ductility than that of the hard magnetic layer (5 to 12) and is pressed with the rotating component (3).

7. The component according to claim 6, wherein the carrier (13) comprises a metallic material, preferably austenitic or ferritic stainless steel.

8. The component according to claim 6 or 7, wherein the hard magnetic layer (5 to 12) was preferably applied to the carrier (13) using of a PVD process.

9. The component according to claim 6, wherein the hard magnetic layer (5 to 12) is adjusted from amorphous to semi-crystalline to crystalline by means of targeted control of the PVD process.
